(19) United States
(12) Patent Application Publication
(10) Pub. No.: US 2007/0041775 A1
(43) Pub. Date: Feb. 22, 2007

(54) Sealing Disc with Slit Opening and Capless Retractable Marking Instrument Using Same

(75) Inventors: Anthony J. Lammers, Gates Mills, OH (US); James M. McDonough, Bradford, PA (US); Jeffrey Scott Plantz, Medina, OH (US); Daniel Jay Wanhainen, Stow, OH (US); John W. Spirk, Gates Mills, OH (US); John R. Nottingham, Bratenahl, OH (US)

Correspondence Address: KEEVICAN WEISS BAUERLE & HIRSCH LLC;(FORMERLY KNOWN AS DKW LAW GROUP LLC), 11TH FLOOR, FEDERATED INVESTORS TOWER, 1001 LIBERTY AVENUE, PITTSBURGH, PA, 15222, US

(73) Assignee: INNODESK, INC., Warrensville Heights, OH (US)

(21) Appl. No.: 11/458,759

(22) Filed: Jul. 20, 2006

Related U.S. Application Data
(63) Continuation-in-part of application No. 10/916,948, filed on Aug. 12, 2004.
(63) Continuation of application No. PCT/US03/04394, filed on Feb. 13, 2003.
(60) Provisional application No. 60/701,102, filed on Jul. 20, 2005.
(60) Provisional application No. 60/356,314, filed on Feb. 13, 2002.

(51) Int. Cl. B43K 7/12

(52) U.S. Cl. 401/107

(57) ABSTRACT

A capless retractable sealed marking instrument has a sealed chamber incorporated in a marker casing. The sealed chamber includes a chamber, a wiper ring, and an annular rim and a seal portion with a cross-slit aperture defining surfaces or flaps which are moved out of contact by a linearly-advanced marker nib to open the seal for extension of the marker nib. The configuration of the disk provides positive sealing force between the lateral sealing surfaces of the seal flaps. In the storage position, the seal effectively closes to protect and preserve the associated component. In a preferred embodiment, a housing member includes a closing member. The closing member engages the disc to seal the slit in the closed position when the associated component is in storage. The disc may include tabs that engage the closing member.

### RELATED APPLICATIONS

This application is a continuation-in-part of pending U.S. patent application Ser. No. 10/916,948 filed on Aug. 12, 2004 entitled “Capless Retractable Sealed Marking Instrument with Forward Chamber” which published Mar. 3, 2005 as publication number 2005-0047844. This application claims the benefit of pending provisional patent application 60/701,102 filed Jul. 20, 2005 entitled “Enhanced Sealing of a Disc with Slit Opening.” U.S. patent application Ser. No. 10/916,948 is a continuation of International Application No. PCT/US03/04394, filed Feb. 13, 2003, entitled “Capless Retractable Sealed Marking Instrument with Forward Chamber” and published Aug. 23, 2003 as International Publication WO/2003/068530. International Application No. PCT/US03/04394 claimed the benefit of U.S. Provisional Patent Application No. 60/356,314, filed Feb. 13, 2002, entitled “Capless Retractable Sealed Marking Instrument with Forward Chamber.” The above identified publications are incorporated herein by reference.

### BACKGROUND OF THE INVENTION

1. Field of the Invention

The present invention pertains generally to marking and writing instruments and, more particularly, to marking and writing instruments having ink-impregnated applicators or cartridges with means to maintain a sealed, airtight chamber in which to house the tip. Further the present invention is directed toward a sealing disc used to provide a sealing function in a seal chamber.

2. Background Information

Capless markers are known in the prior art. Commonly-owned U.S. Pat. No. 6,033,141 discloses a capless marker design and is hereby incorporated by reference in its entirety. Generally, these markers provide a retraction and extension carriage to permit the tip of the marker to be concealed within a housing when not in use so as to avoid accidentally contacting clothing or papers when not in use.

Some capless markers include a seal to prevent the drying of the tip due to evaporation of ink into the atmosphere. One such marker is disclosed in the above-referenced patent, U.S. Pat. No. 6,033,141, issued to Blaustein, et al. The marker discloses a single-piece seal mounted adjacent a front cowling. The single-piece seal includes a concave membrane with a slit to permit the extension of the ink cartridge tip for writing and closes upon retraction of the ink cartridge.

A variety of carriage mechanisms may be employed for linear movement of the cartridge within a marker housing. Because the carriage, by necessity, involves moving parts, there is a likelihood that the carriage mechanisms do not provide an airtight closure at the end opposite the writing tip of the marker. Therefore, infiltration of air from the carriage end of the marker can occur despite the placement of a seal adjacent the tip.

There is thus absent from the prior art a retractable capless marker which provides a securely-maintained, airtight chamber of a relatively simple design, which eliminates the need for a separate cap, and which prevents drying of the nib due to air infiltration from either the front or rear end of the marking instrument.

Further there is a need to provide a secure sealing mechanism such as a sealing disc. Some current disc sealing designs, using elastomeric materials for the disc, rely solely on the resilient properties of the elastomeric material to close the slit and provide a sealing member. These designs have limitations in that the materials have difficulty in closing the slit tightly to provide an adequate seal, and if the disc design and material initially provides an adequate seal, it may not satisfactorily perform and meet the requirements of the application under multiple activations of the seal system.

Other sealing element designs that provide similar functions usually include additional components that enhance the closing of a slit or other openings in a seal system. These include external, spring-like components that apply forces directly to the seal. Some of these seals are of a disc shape, and others are of other shapes including, but not limited to, what is known in the industry as a “duckbill” shape. Still other designs have the shape of a cylinder with a lid.

There is a need for a sealing disc structure that is designed to provide a secure seal.

### SUMMARY OF THE INVENTION

The capless marker is a highlighter-type of marker that incorporates seal technology to allow the marker to be used without a cap. Preferably, the marking instrument uses a fluorescent-highlighter ink which may be produced in multiple colors, such as yellow and pink, although virtually any type of ink or shape of nib may be used with this device.

What is disclosed is a capless retractable sealed writing instrument including an elongated marker housing with an axial opening. A marker reservoir having a marker nib is disposed within a marker carrier mechanism in the marker housing. The marker carrier mechanism moves the marker reservoir and marker nib linearly within the marker housing to extend and retract the marker nib through the axial opening in the marker housing.

A sealing means includes a sealing chamber, a first seal piece, and a second seal piece. The chamber has a peripheral wall defining a hollow bore. The chamber is disposed coaxially within said reservoir. The reservoir extends at least partially into the hollow bore of the chamber when it is in the retracted position.

The sealing chamber comprises a generally circular peripheral wall defining a hollow bore suitable for passage of a cylindrical reservoir portion. An annular forward terminus at one end of the peripheral wall is adapted to compress an annular rim of the first seal portion. An annular rearward terminus at an opposite end of said peripheral wall has a flat edge adapted for compressing an elastomeric wiper seal encircling the reservoir portion.

The seal portion comprises an annular flange portion in contact with the forward terminus, a circular head portion; and a hollow cylindrical sidewall connecting said forward terminus and said head portion. The head portion includes a flexibly-resilient, re-closable aperture adapted to permit extension and retraction of the marker nib through the head.

One advantage of such a marker is that a detachable cap is not required in order to prevent the marker from drying out. Frequently, detachable caps are set aside and lost or forgotten by the user, and much of the ink remaining in the marker is wasted when the nib dries out and becomes hard.

A disc according to the present invention provides a sealing function in a system that allows for the passage and return of an element through the disc when desired with an activation of other member components of the system. The disc includes a slit through a wall of the disc that acts as a passageway when opened to allow an element to move through the disc and closes as the element is retracted back through the slit of the disc.

Additional features of the disc of the present invention, that enhance the closing and sealing of the slit, are provided on the disc or adjacent to the disc in a component of the system that applies a force to the disc by direct contact to the disc. An intent of these additional features is to ensure complete closure of the slit, and thereby provide improved sealing of the system.

The sealing enhancement feature of the present invention allows for the use of a seal design that is basically a disc. The disc is not necessarily of a flat shape; it may be relatively flat or may be of a shape that allows for additional geometric features that result in the disc having portions that extend beyond that of a flat disc.

One such geometric feature modification is a disc with a portion that provides a cup-like or cylinder shape. To enhance the closing and sealing of a slit in a disc of this type, the resilience of the elastomeric material is supported with design features incorporated into the disc that interfere with mating components that apply forces to the disc that are transferred to the walls of the disc adjacent to the slit, and thereby push the walls together and close the slit tightly to result in an enhanced seal.

An example of this type of sealing system being used in an application would be as a sealing mechanism in a retractable marker-type writing instrument. In this application, the writing tip of the marker is stored in a seal chamber to prevent the drying out of the ink in the tip, which would render the marker inoperable. If the marker tip is stored in a closed seal chamber, the ink will not dry out, and the marker will remain functioning, as long as the ink supply has not been consumed in normal usage. The challenge to the seal chamber is to provide a feature that allows the marker tip to be moved to a position outside of the seal chamber for intended use and then to be retracted back into the seal chamber for storage until the next intended use. The opening and closing of the seal chamber, as well as the passage of the marker tip, to a position outside of the seal chamber for normal usage is allowed through a component of the seal chamber that includes a feature and provides a means to allow the marker tip to move out of the seal chamber when the marker is activated.

This is accomplished by including a passageway in the seal chamber or one of its components. One such design has a sealing disc as a component of the seal chamber, and this disc has a slit that opens and closes, providing a means to allow the marker tip to move out of a closed seal chamber and to return to the seal chamber and reseal, preventing marker tip dry-out.

It is therefore an object of the present invention to provide an airtight seal in which to maintain the marker nib when in the retracted position.

It is a further object of the present invention to eliminate the need for a removable cap to prevent evaporation of the ink and drying of the nib.

It is yet another object of the present invention to maintain, in a fixed position, a sealed chamber for storing the marker nib and to ensure a positive engagement of a secondary seal with the chamber.

It is yet another object of the present invention to provide a disc seal with enhanced sealing capabilities to assure a complete seal.

### BRIEF DESCRIPTION OF THE DRAWINGS

FIG. 1 is an elevational view of a sealed capless marking instrument;

FIG. 2 is a sectional view taken along lines 3-3 of FIG. 1;

FIG. 3 is an exploded isometric view illustrating the arrangement of internal parts;

FIG. 4 is an enlarged sectional view of the tip assembly portion;

FIG. 5 is a cross-sectional view of the tip portion when the nib is in the extended position;

FIG. 6 is an isometric view of the sealed chamber;

FIG. 7 is an elevational sectional view of the sealed chamber;

FIG. 8 is a plan view of the seal piece;

FIG. 9 is a cross-sectional view of the seal taken along the lines 9-9 in FIG. 8;

FIG. 10 is an isometric view of the seal piece;

FIG. 11 is a plan view of an alternate concave seal piece;

FIG. 12 is a cross-sectional view of the alternate concave seal taken along the lines 12-12 in FIG. 11;

FIG. 13 is an isometric view of the seal piece;

FIG. 14 is a sectional schematic view of an alternate chamber configuration;

FIG. 15 is a sectional schematic view of an alternate chamber configuration;

FIG. 16 is sectional schematic view of an alternate chamber configuration;

FIG. 17 is an isometric view of an alternate sealed chamber with internal ribs;

FIG. 18 is a cross-sectional view of an alternate sealed chamber with internal ribs;

FIG. 19 is a top view of an embodiment disc seal according to the present invention;

FIG. 20 is a cross-sectional view of the disc seal shown in FIG. 19;

FIG. 21 is a top view of a another embodiment disc seal according to the present invention;

FIG. 22 is a cross-sectional view of the disc seal as shown in FIG. 21;

FIG. 23 is a top view of the embodiment of FIGS. 19-20 disc seal illustrating members of a mating housing component; and

FIG. 24 is a cross-sectional view of the disc seal as shown in FIG. 23.

### DETAILED DESCRIPTION OF THE INVENTION

A complete understanding of the invention will be obtained from the following description when taken in connection with the accompanying drawing figures, wherein like reference characters identify like parts throughout. For purposes of the description hereinafter, the terms “upper,” “lower,” “right,” “left,” “vertical,” “horizontal,” “top,” “bottom,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

The present invention discloses a means for sealing the nib portion of a marking instrument by trapping the nib within a small, airtight chamber at the forward or writing end of the instrument. A reclosable seal is compressed against the chamber, with a resilient slit or slits that separate when the marker nib is extended through the seal for writing, and reclose to maintain an airtight barrier when the nib is again retracted. An O-ring maintained in compression against the housing forms the nib seal by friction fit against the wall of the ink reservoir. A secondary seal at the rear of the ink reservoir is maintained, so as to prevent exposure of the ink to air that can cause premature drying, from the end opposite the nib.

By this means, a small, airtight pocket is formed around the marker nib when in the retracted position, thereby substantially eliminating evaporation of the ink through the nib. Secondarily, the rear portion of the reservoir is also sealed from the atmosphere to prevent evaporation of ink from the internal fibers in the reservoir. These two sealing means allow the marker to move longitudinally along the axis of the marker by conventional retracting means, and to maintain a seal when retracted, thus only exposing the nib of the marker to air when in use.

The Marking Instrument Housing

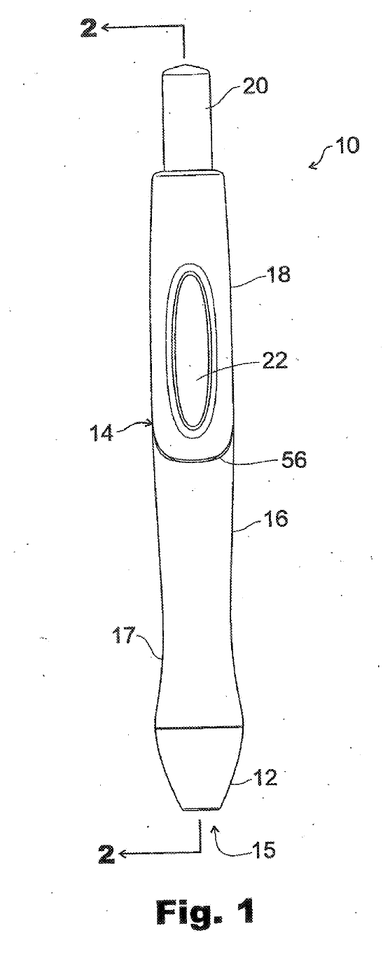

Referring first to FIG. 1, the sealed capless marking instrument is generally designated as 10. A tip portion 12 is attached at the forward end of instrument 10 to a housing portion 14. Housing portion 14 is comprised of a first housing portion 16 and a second housing portion 1 8. A reservoir plunger 20 protrudes from second housing portion 18 from within housing 14.

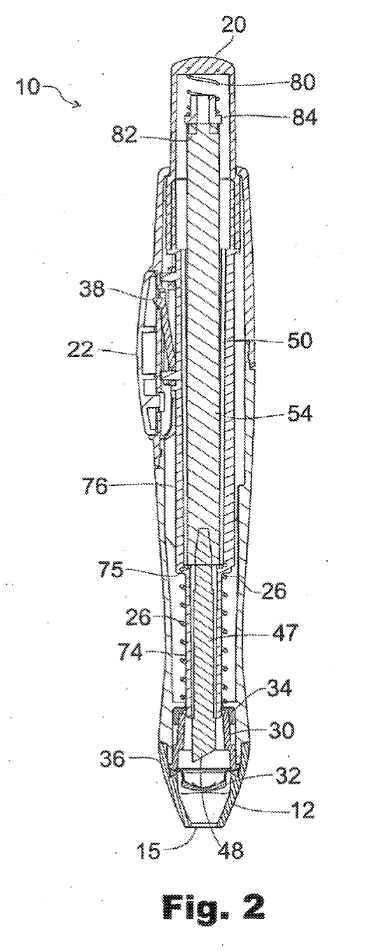

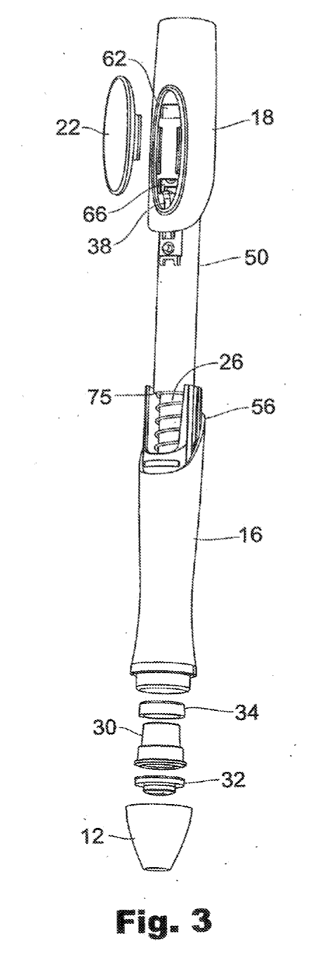

Referring next to FIGS. 2 and 3, release button 22 is provided for retracting a reservoir assembly 54 to conceal nib portion 48. Reservoir assembly 54 is contained within housing portions 16, 18, which join to form the single housing portion 14. At the forward end of the marking instrument used for writing, the tip portion is attached via a solvent bond or a snap connection 36 to first housing portion 16. A snap connection 56, 36 is comprised of a plurality of complementary ridges that interlock when forced together. Other connection means, such as threads and bayonet-type fittings, are also effective. Tip portion 12 engages first housing portion 16 via snap connector 36 and maintains the position of chamber portion 30 against a wiper seal 34 made of elastomeric material, such as silicon rubber, at one end and seal portion 32 at the forward end. Wiper seal 34 has a generally L-shaped, cross-sectional configuration conformable to the outer diameter of chamber portion 30. Alternately, the wiper seal 34 may be replaced by an O-ring or a gasket. Chamber portion 30 maintains an airtight cavity in which nib portion 48 is encased when marker 10 is in the retracted position. The limited space contained within chamber portion 30 prevents nib portion 48 from drying when in the retracted position, thereby extending the shelf life of the capless marker 10.

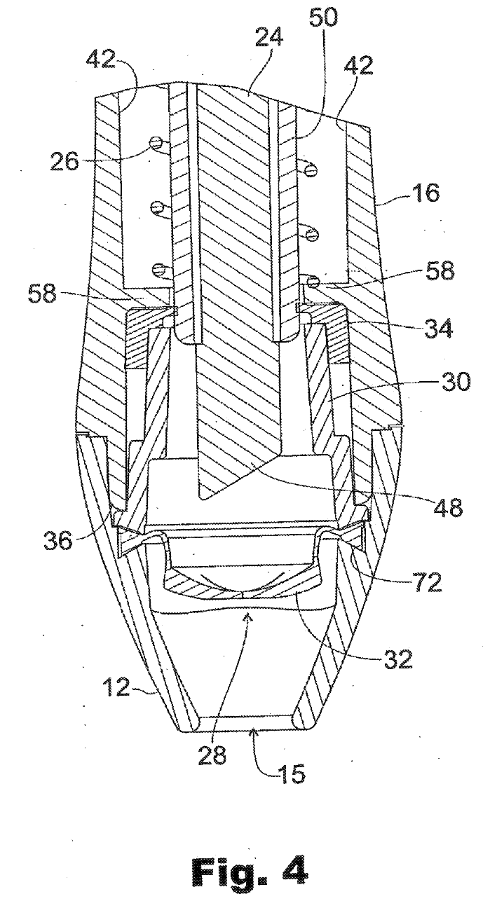

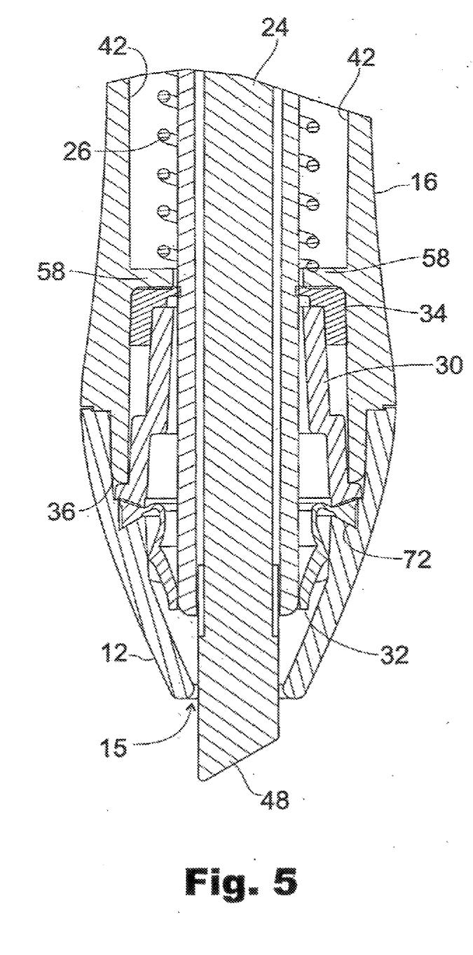

Referring next to FIGS. 4 and 5, the forward portion of marker 10 is illustrated as an enlarged, cross-sectional view. The tip portion 12 attaches to the first housing portion 16 by means of snap connection 36. The tip portion 12 protects and conceals the concave seal portion 32 which rests adjacent shoulder 72. The chamber portion 30 is maintained within the forward end of the first housing portion 16 by the tip portion 12 when the tip portion 12 is engaged with first housing portion 16. Chamber portion 30 abuts wiper seal 34. Wiper seal 34 rests against an annular rim portion 58 projecting radially-inward from a housing lining wall 42. Rim portion 58 provides a stop limit to prevent axial displacement of the chamber portion 30. Compression spring 26 rests against annular rim portion 58 on the opposite side of wiper seal 34 within the hollow interior of the marker housing portion 14. Compression spring 26 is compressed when the marker 10 is in the extended position and stores energy that is released when release button 22 is depressed, forcing the reservoir assembly 54 to return to the retracted position.

As illustrated in FIGS. 2 and 4, when in the retracted position, the nib portion 48 is situated within the hollow interior of the chamber portion 30, so as to trap the nib portion 48 in an airtight, sealed chamber. The seal is achieved by the closure of slits 28 in seal portion 32. Slits 28 permit the penetration of nib portion 48 when the reservoir assembly 54 is extended to expose the marker for writing. When the seal portion 32 is closed in the retracted position, the forward end of the chamber portion 30 is sealed by way of the rim portion of seal 32. The seal portion 32 is further described in detail below. The opposite end of the chamber portion 30 is sealed by way of a wiper 34 which is compressed against the annular rim portion 58 and which also snugly fits about the external diameter of capillary reservoir housing 50, so as to prevent any air infiltration from the end of the marking instrument opposite the tip portion 12.

A contoured shape is preferred in the marker housing, with an indentation 17 formed in the first housing portion 16 located proximate to the tip portion 12. This assists the user in gripping the instrument for ease of writing. Housing portion 14 has a generally oblong, cross-section in second housing portion 18, transitioning into a circular cross-section in bottom portion 16. The non-circular geometry helps prevent the marking instrument from rolling on a flat surface, such as a desk, when it is laid down. The circular terminus of housing portion 14 facilitates the connection of a substantially conical tip portion 12 to the housing portion 14.

The Seal Chamber

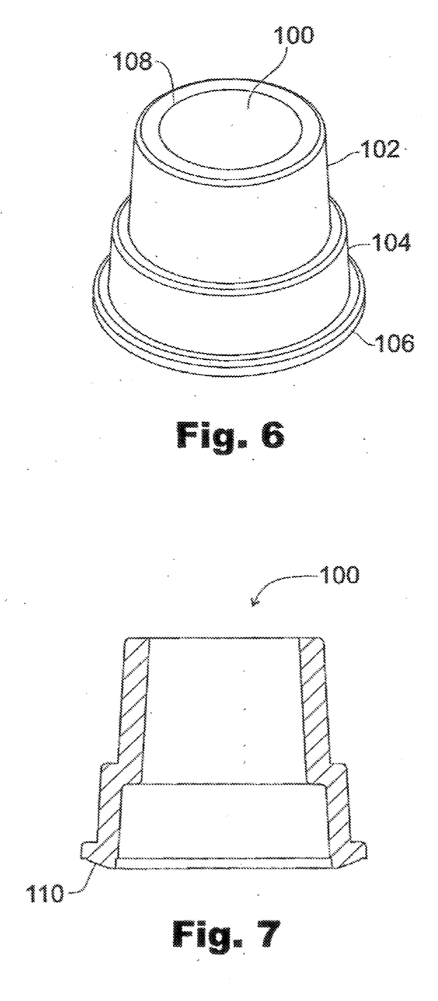

Referring next to FIGS. 6 and 7, the chamber portion is generally designated as 30. An aperture 100 extends through a top rim portion 108 through which the reservoir assembly 54 extends. Exterior walls 102, 104 are stepped at such a way as to form a tandem pair of cylindrical walls, first wall 102 being the wall portion nearest aperture 100. First wall 102 is of a smaller diameter than second wall 104. While the walls 102, 104 are generally cylindrical, as it is desirable to include a slight taper from the one end to the opposite end in order to facilitate injection molding processes, which are more easily accomplished when the workpiece includes a slightly tapered exterior wall. Second wall 104 attaches to a flange 106 at the end opposite aperture 100.

The chamber portion 30 is similar in appearance to a thimble open at both ends, and includes a flat top rim portion 108 which engages wiper seal 34 and forces it against annular rim portion 58. Rim portion 58 and wiper seal 34 form an airtight seal around reservoir assembly 54 at one end of chamber portion 30. At the opposite end, flange 106 engages the seal portion 32 and provides an airtight fit.

FIGS. 4 and 7 illustrate a dovetail recess 72 formed at the intersection of flange 106 and tip portion 12, that captures flange portion 104 of seal 32 to prevent the seal from becoming dislocated. An angled surface 110 on the bottom side of flange 104 depresses the pliable material of the annular flange portion 104.

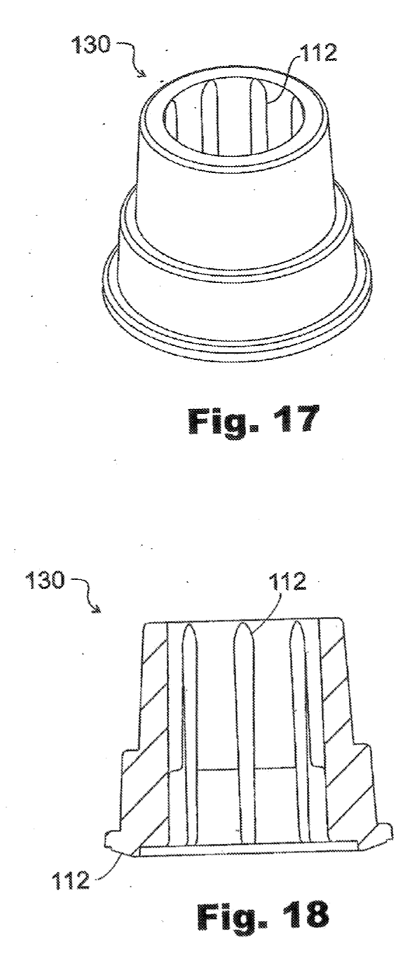

FIGS. 17 and 18 illustrate an alternate configuration of a chamber portion 130, having a plurality of interior vertical ribs spaced generally symmetrically about the internal circumference of the chamber walls.

The Seal

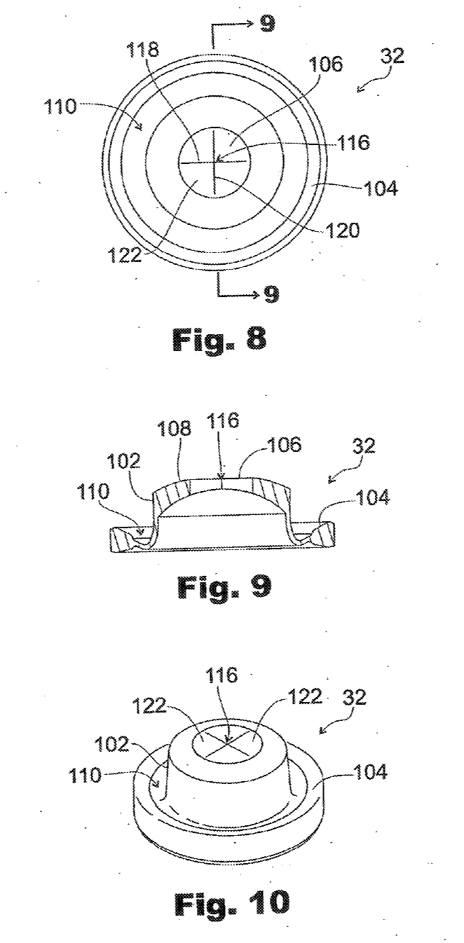

Referring next to FIGS. 8-10, seal portion 32 is shown in a preferred arrangement. Various configurations may be employed in constructing seal portion 32. One such device is shown and described in U.S. Pat. No. 5,439,143, which is expressly herein incorporated by reference in its entirety. This device, entitled “Dispensing Valve For Packaging,” is manufactured by Liquid Molding Systems, Inc., of Midland, Mich. While not used as a valve in the present invention, the present invention employs the resealable properties of such a valve to seal the marker nib 48 within the forward chamber 30. For clarity, the device is referred to as a seal for purposes of this invention. Without setting forth the entire details of the seal construction, the relevant portions will be discussed. The seal 30 contains aperture 116 with a cross-slit construction that includes two intersecting linear slits 118 and 120 that extend through the center portion 106. Slits 118, 120 are formed preferably by slicing through the center portion 106 of seal portion 32.

The illustrated seal portion 100 comprises an integral, single-piece construction, preferably made of a resiliently flexible and pliable material, such as silicon rubber. A thin barrier of propylene glycol or other non-toxic gel may be applied to enhance the sealing properties and to lubricate the aperture 116 and the marker nib 48 to reduce wear on the seal 100 due to repeated operation of the retracting mechanism.

Flange portion 104 is compressed between forward chamber 30 and shoulder 72 of tip portion 12. Flange portion 104 is connected to longitudinal sidewalls 102 via flexible trough 110. Longitudinal sidewalls 102 of seal portion 100 extend outwardly forming a hollow cylindrical guide path for marker nib 48. Sidewalls 102 terminate into head 108. Head 108 has an arcuately-shaped marginal portion tapering from sidewalls 102 to a generally flat center portion 106. An aperture 116 has a pair of perpendicularly-intersecting linear slits 118, 120 that extend completely through center portion 106, and their distal ends are tapered slightly inwardly from the radial edge of center portion 106. Slits 118, 120 define four flaps 122, which flex outwardly and back corresponding to the direction of travel of the nib 48.

Flaps roll outwardly when nib 48 is in the extended position, maintaining a slight pressure around the shaft of the nib 48. When the nib 48 is retracted, flaps 122 gently wipe any excess ink and return to a closed, sealed position.

It is to be understood that aperture 116 may assume many different shapes, sizes and/or configurations in accordance with the marker characteristics desired. For example, aperture 116 may comprise a single slit, particularly when smaller or narrower streams are desired. Aperture 116 may also include three or more slits, for example, as when a geometric cross-sectional reservoir, such as a hexagonal tube, is desired. Other forms of apertures 116, such as holes, duck bills, etc., may be incorporated into seal 32 in lieu of the cross-slits to enhance the sealing properties.

Carriage Mechanism

Reservoir plunger 20 is attached by way of a multi-ringed snap connection and complementary ridges on a reservoir connection 40, which interlock with each other when pressed together. In the disclosed embodiment, reservoir plunger 20 is elliptical in cross-section, and the reservoir connection 40 has a corresponding elliptical cross-section on the side that couples with the reservoir plunger 20.

As shown in FIG. 2, a recoil spring 80 may be optionally deployed within the reservoir plunger 20. The purpose of recoil spring 80 is to cushion the reservoir from the recoil impact when release button 22 is depressed and spring 26 retracts nib 48. Cushioning is desirable in order to prevent or limit deformation of ink fibers (not shown) from occurring within reservoir 50.

A plug 82 fits snugly into the end of capillary reservoir 50 to seal the internal fibers 54 from atmosphere. Shelf 84 on plug 82 provides a circular base for securing one end of recoil spring 80 within reservoir plunger 20. Hub 86 extends from plug 82 to position recoil spring 80.

Referring next to FIGS. 2 and 3, the capillary reservoir housing 50 is slidable along a longitudinal axis to permit the nib portion 48 to extend through concave seal portion 32 and beyond housing portion 14 through an opening 15. The release spring 38 is attached to the capillary reservoir housing 50 via a pair of protrusions 64 on reservoir connection 40. Protrusions 64 engage release spring 38 in a fixed position relative to the release button 22 and a slot 62 when in the retracted position. By pressing the reservoir plunger 20, the capillary reservoir housing 50 advances along the longitudinal axis until the release spring 38 engages the release button 22. When external pressure is applied to the release button 22, for example, by a person's thumb, reservoir assembly 54 returns to the retracted position by releasing the energy stored in compression spring 26. Release spring 38 is forced back until it engages the first slot 62.

It is to be understood that the disclosed carriage mechanism employed in the present invention represents but one of many such mechanisms known in the art. For example, a rotary cam-follower or a ratchet mechanism may be substituted for the release spring/pushbutton arrangement disclosed herein.

Reservoir Assembly

Referring next to FIGS. 2 and 3, the reservoir assembly is illustrated. FIG. 2 shows the nib portion 48 which is adjacent one end of capillary reservoir assembly 54. Nib portion 48 is maintained adjacent capillary reservoir assembly 54 partially by a friction fit between the inner walls of capillary reservoir assembly 54 and a cylindrical shaft 47 of nib portion 48. Nib portion 48 extends backward into capillary reservoir assembly 54 in which the ink is impregnated. Capillary reservoir assembly 54 is contained within capillary reservoir housing 50. Capillary reservoir housing 50 is comprised of a pair of tubular sections 74, 76. First tubular portion 74 is of a smaller diameter which contains the forward nib portion 48 extending out of the end of the first tubular portion. The first tubular portion 74 is joined with the second tubular portion 76 of a larger diameter, which extends rearward into the hollow interior cavity of reservoir plunger 20. A shelf 75 is defined at the connection between tubular sections 74, 76. Shelf 75 provides a circular base for securing one end of compression spring 26. The second tubular portion 76 may contain a larger diameter filament or capillary reservoir assembly 54. The nib portion 48 and capillary reservoir assembly 54 are constructed of a polyester fiber in the disclosed embodiment and impregnated with a writing fluid, such as fluorescent ink or the like.

A wide variety of inks may be employed in the reservoir assembly 54; however, the characteristics of the ink used in the disclosed embodiment include odorless, quick-drying, water-resistant, fade-resistant, and non-toxic fluid consistent with ASTM 4236 Standard. The nib portion 48 may be chisel-shaped for highlighting purposes or more pointed for writing purposes.

The seal 32 may incorporate a thin plastic membrane covering the seal portion 32, which is punctured at the first use so as to provide additional protection and preserve the ink stored therein during the shelf life period prior to the first use.

Alternate Seal Configurations

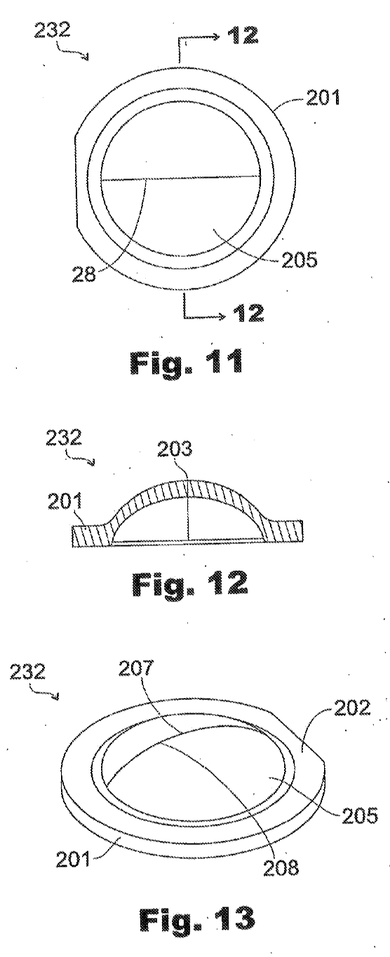

Concave seal 232, shown in FIGS. 12-14, is held within the marker tip portion 12. The seal 232 includes a generally annular rim 201 with an internal diameter (ID) at least equal to or greater than a diameter of an opening 15.

Annular rim 201 includes a flat edge 210. Flat edge 210 provides alignment means to orient the direction of the slit 28 to coincide with the edge of a nib chisel point 49. Flat edge 210 prevents the rotational movement of the seal 232, relative to chamber portion 30 and tip portion 12, after the tip portion 12 is snapped together with the housing 14. When using a flat edge 210 type rim 201, the chamber portion 30 may have a flat, rather than tapered, flange bottom 110. A semi-circular or pointed bead (not shown) optionally depends from the flange bottom 110 that will impinge upon the rim 201 for better engagement with the chamber portion 30.

The seal 232 further includes a flexible concave disk 202 attached to and within the circular interior area defined by the annular rim 201. As best shown in FIG. 13, the concave disk 202 has a cross-section in the form of an arc A, with an apex 203 of arc A oriented to face the marker nib 48 when the marker nib 48 is in a fully-retracted position within the marker housing 14. The concave disk 202 further has a full-diameter, full-width slit 204 through the radial center of the disk, which forms two cooperative sealing disk halves 205, 206 which are deformable to allow passage of the marker nib through the slit upon linear advancement of the marker cartridge and marker nib by the marker carrier mechanism to an extended position.

The concavity of the disk halves 205, 206 biases mating edges 207, 208 tightly together to form a highly-effective atmospheric seal to the interior of the marker housing, thereby retaining the ink moisture in the marker nib and the marker cartridge. The concavity of the disk halves with an apex 203 oriented into the interior of the marker casing and toward the marker tip is especially effective in forming a seal sufficient to retain moisture within the marker cartridge and nib. As shown in FIG. 5, the marker nib is linearly projected through the seal 232 and opening 15, thereby deflecting the disk halves 205, 206 to spread about the slit. In this position, the disk halves are tightly wrapped about the circumference of the marker cartridge, thereby effectively sealing the section of the marker reservoir, which remains in the housing 14 from the atmosphere, while the marker nib is exposed. Upon retraction, the disk halves 205, 206 effectively wipe the marker nib clean as they are brought back to the sealed concave position by the linear motion of the cartridge. The concave configuration of the disk halves 205, 206 is especially effective in establishing a tight seal since the amount of force required of the tip to urge the halves apart is greater than required for a convex, outwardly-oriented seal. Also, upon retraction, the marker nib mechanically drags the disk halves back to the concave position, forcing the mating surfaces together to reestablish the seal 32.

The seal 32 is preferably formed or molded in the described configuration from a suitable silicon material such as GE.®. Silicon SE 6260, a high-performance, moldable, and pigmentable silicon compound.

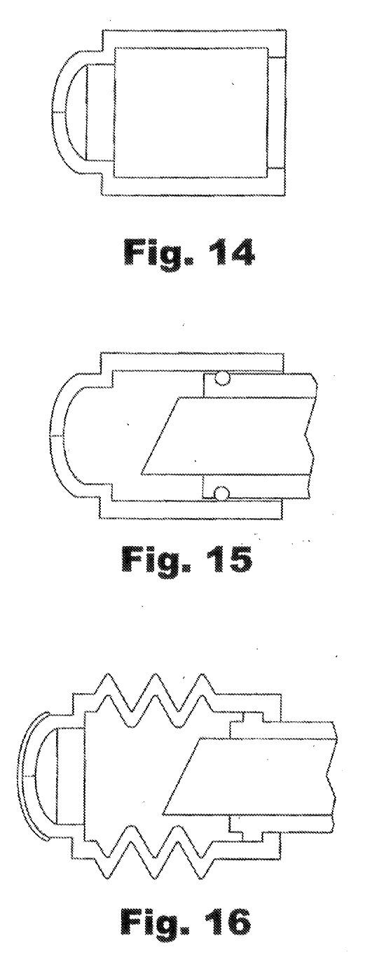

Referring to FIGS. 14-16, it is also within the scope of the present invention to include the flexible seal portion attached to the forward chamber, either by adhesively affixing the seal portion on the rim or by integrally molding the seal onto the forward chamber (FIG. 14). Additional configurations are shown on FIGS. 14-16 and include a traveling sealed chamber (FIG. 15) and a bellows-type extendable seal (FIG. 16) attached at one end to the reservoir cartridge.

A vent tube (not shown) may be placed longitudinally within capillary reservoir assembly 54 to equalize pressure within the reservoir to prevent vapor-lock and facilitate the flow of ink to the nib 48.

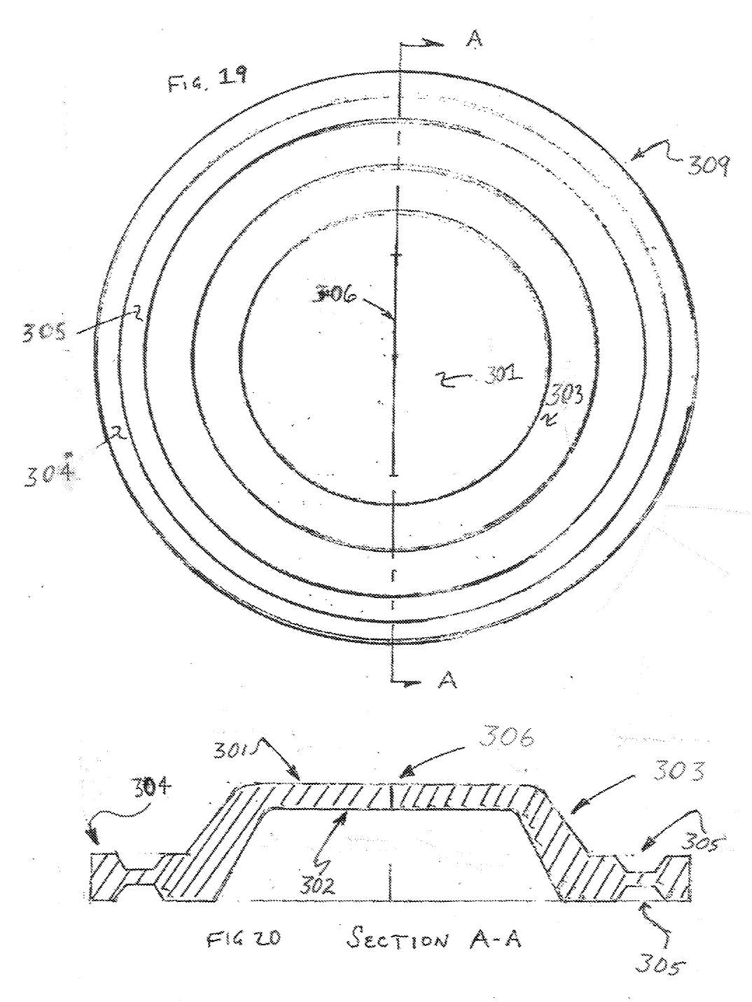

Referring to FIGS. 19 and 20, an embodiment of a disc seal 309 of the present invention includes a seal top wall 301 and a seal bottom wall 302. The seal top wall 301 and the seal bottom wall 302 are attached to a seal side wall 303. A through slit 306 extends through the seal top wall 301 and the seal bottom wall 302, thereby defining an opening in the disc seal 309 (i.e., the through slit 306 extends through the material of the disc seal 309). The slit 306 may be linear, non-linear, continuous, or non-continuous. For example, the slit 306 may be a single straight line, multiple straight lines, that are set at varying degrees and/or intersecting to form a shape or pattern of an opening in the seal, a “cross” with two intersecting lines at 90 degrees, a tri leg pattern, or a wavy line.

The disc seal 309 includes a seal rim 304 with two seal grooves 305. One seal groove 305 is located on an upper surface of the seal rim 304 and another seal groove 305 is located on a lower surface of the seal rim 304.

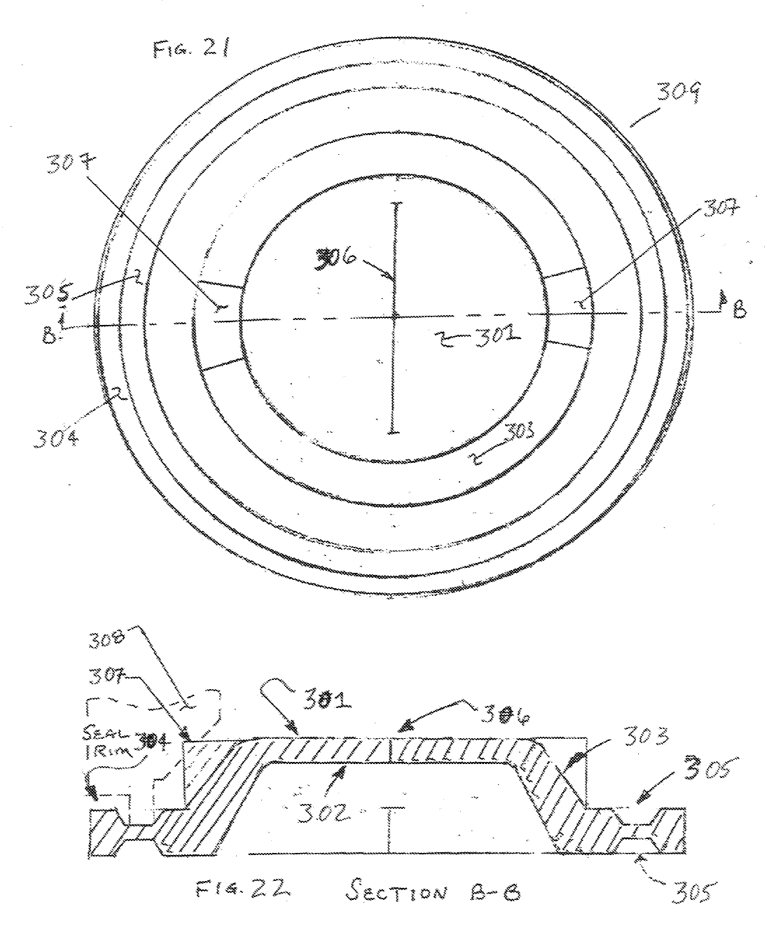

Referring to FIGS. 21 and 22, another embodiment of a disc seal 309 is similar to the embodiment disc seal 309 of FIG. 19 and 20, but additionally includes a pair of slit closing tabs 307. Each of the pair of slit closing tabs 307 is located approximately 180 degrees from the other of the pair of slit closing tabs 307 and positioned approximately perpendicular to a longitudinal axis (main linear axis) of the through slit 306.

The pair of slit closing tabs 307 is in interference contact with a slit closing feature 308 in a mating housing component of a marker as discussed above. The slit closing feature 308 may be continuous for 360 degrees, thereby making interference contact with each of the pair of slit closing tabs 307 without requiring orientation of the sealing disc 309 with the mating housing to uniquely align the slit closing tabs 307 with the slit closing feature 308 of the housing. In an alternative embodiment, the slit closing feature 308 is not 360 degrees, but includes two or more segments that would be oriented and aligned with slit closing tabs 307 to make the interference contact. The interference contact applies a closing force to the material between the seal top wall 301 and the seal bottom wall 302, thereby sealing the through slit 306.

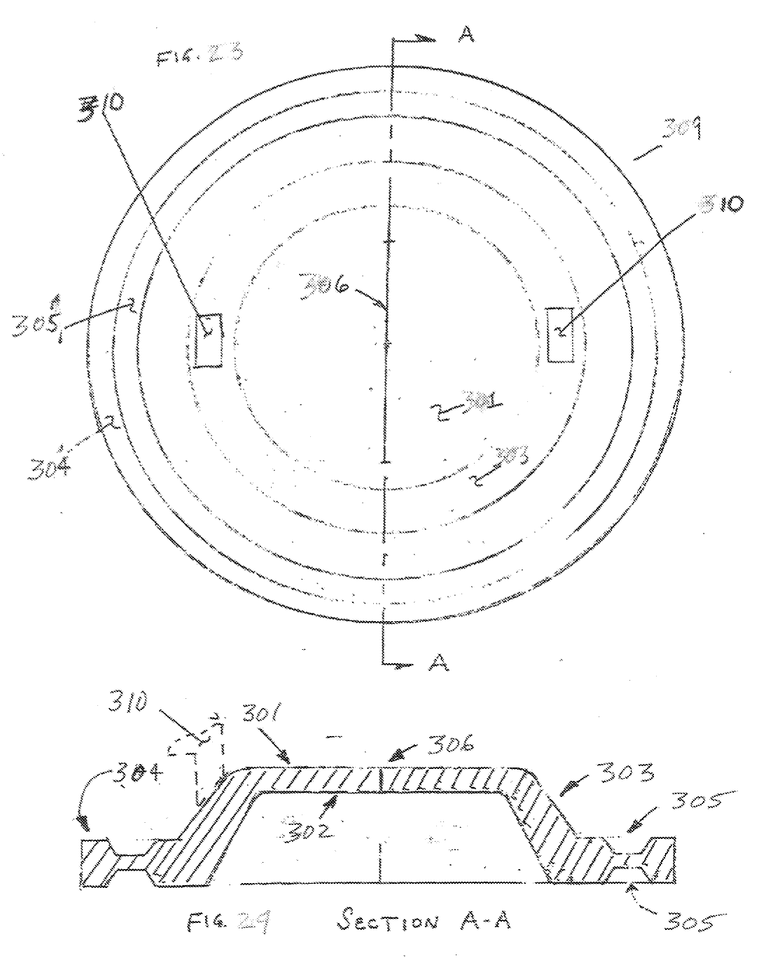

Referring to FIGS. 23 and 24, the embodiment disc seal 309 of FIGS. 19 and 20 is used in conjunction with a slit closing feature 308 in a mating housing component of a marker. The slit closing feature 308 includes a pair of members 310. Each of the pair of members 310 is located approximately 180 degrees from the other of the pair of members 310.

After assembly of the marker, each of the pair of members 310 is positioned approximately perpendicular to a longitudinal axis (main linear axis) of the through slit 306. Thus, the pair of members 310 is in interference contact with the seal side wall 303. The interference contact applies a closing force to the material between the seal top wall 301 and the seal bottom wall 302, thereby sealing the through slit 306.

The disc seal may be constructed of natural and synthetic rubbers and elastomers, including Buna N, Butyl Rubber, Polyurethane, Silicone, and EPDM.

The disc seal may be manufactured by injection molding or compression molding, with the slit being formed during a secondary slitting or cutting operation. The slit may be formed via one or multiple slitting or cutting operations.

In these embodiments of present invention, the interference contact provides forces to the disc seal, or alternative sealing device, to enhance the closing of the slit or opening to give a sealed closure. A number of alternative embodiments of the designs and features providing an interference contact or fit between the disc seal and a housing or other component that is part of the assembly or seal chamber are possible and envisioned. The invention is not limited to materials, manufacturing processes, interference locations and shapes, and contacting components. Additionally, while described in relation to a retractable marker, the present invention is not limited thereto.

Although the present invention has been described above by reference to an embodiment of the invention, the present invention is not limited to the embodiment described above. Modifications and variations of the embodiment described above will occur to those skilled in the art, in light of the above teachings without departing from the spirit of the present invention. It is the present invention, therefore, to be limited only as indicated by the scope of the claims appended hereto and equivalents thereto.

What is claimed is:

1. A seal for a seal chamber, comprising:
a rim;
a plate extending from the rim; and
an opening passing through the plate, wherein the opening is substantially a linear slit extending a portion of a diameter of the plate.

2. The seal of claim 1 further including a pair of tabs, each of the pair of tabs located approximately 180 degrees from the other of the pair of tabs and positioned approximately perpendicular to the longitudinal axis, wherein the pair of tabs are configured to contact a closing member in a mating housing member which causes the slit to seal in a closed position.

3. A system for sealing a seal chamber, comprising: a disc, the disc including:
a side wall, the side wall being substantially circular;
a top wall extending from the side wall and within a perimeter of the side wall;
a bottom wall extending from the side wall and within a perimeter of the side wall and substantially parallel to the top wall;
a slit extending through the top wall and the bottom wall defining an opening; and
a longitudinal axis running through the slit;
a housing member; and
a closing member extending from the housing member, the closing member being substantially circular and positioned to engage the disc,
wherein the closing member engages the disc causing the slit to seal in a closed position.

4. The system according to claim 3, wherein the disc further includes a pair of tabs, each of the pair of tabs located approximately 180 degrees from the other of the pair of tabs and positioned approximately perpendicular to the longitudinal axis, wherein the closing member engages the pair of tabs.

5. A capless retractable sealed writing instrument comprising:
an elongated marker housing with an axial opening;
a marker reservoir having a marker nib and held within a marker carrier mechanism within the marker housing, the marker carrier mechanism operative to linearly move the marker reservoir and marker nib within the marker housing, to extend and retract the marker nib through the axial opening in the marker housing;
a sealing mechanism having a sealing chamber, a first seal piece and a second seal piece; and said chamber having a peripheral wall defining a hollow bore, the chamber disposed coaxially with said reservoir, the reservoir extending at least partially into said hollow bore, wherein at least one seal piece comprises a rim, a plate extending from the rim, and an opening passing through the plate, wherein the opening is substantially a linear slit extending a portion of a diameter of the plate.

6. The capless retractable sealed writing instrument of claim 5, wherein said first seal piece is maintained in abutting relationship with said chamber at a first end of said chamber, and said second seal piece abutting said chamber adjacent an opposite end of said chamber, said first seal piece held within said marker housing proximate to the open end of said marker housing, said first seal piece having a generally-annular rim held within the marker housing in a plane generally perpendicular to a longitudinal axis of said marker housing.

7. The capless retractable sealed writing instrument of claim 6, wherein the sealing chamber portion comprises a generally-circular, peripheral wall defining a hollow bore suitable for passage of a cylindrical reservoir portion therethrough; an annular forward terminus at one end of said peripheral wall adapted for compressing an annular rim of a seal portion; and an annular rearward terminus at an opposite end of said peripheral wall having a flat edge at one end adapted for compressing an elastomeric wiper seal encircling the reservoir portion.

8. The capless retractable sealed writing instrument of claim 5, wherein the marker carrier mechanism comprises a marker reservoir receiver, a release spring, and first and second apertures for capturing said release spring in either a retracted position or an extended position, and a plunger in linear alignment with said reservoir, said plunger being movable along a longitudinal axis of said writing instrument.

9. The capless retractable sealed writing instrument of claim 5, wherein the marker carrier mechanism comprises a marker reservoir receiver connected to a pushrod having indentations in contact with a ratchet and a plunger in linear alignment with the pushrod.

10. The capless retractable sealed writing instrument of claim 5, wherein said chamber wall also comprises first and second wall portions, wherein said wall portions are attached at a step portion, said first wall portion having a larger outside diameter than said second wall portion.

11. The capless retractable sealed writing instrument of claim 5, wherein said housing further comprises a tip portion in engagement with a first end of the marker housing and axially aligned therewith, and an axial opening for the marker nib to be advanced by the marker carrier mechanism through the seal portion and further through the axial opening in the tip portion to reach a fully-extended position exposing the nib for writing.

12. The capless retractable sealed writing instrument of claim 11, wherein said forward terminus having an angled face portion adapted to mate with the flange portion to form a dovetail shaped joint with the tip portion.

13. The capless retractable sealed writing instrument of claim 5, wherein the peripheral wall of the seal chamber includes an intermediate shoulder defining a first outer diameter and a second outer diameter along said peripheral wall, and said peripheral wall also being tapered axially slightly inwardly.

14. The capless retractable sealed writing instrument of claim 13, wherein said forward chamber portion also comprises two or more rib portions projecting radially inwardly from said peripheral wall and extending longitudinally along at least a portion of the interior of said peripheral sidewall, to prevent the seal portion from inverting upon retraction.

15. The capless retractable sealed writing instrument of claim 5, wherein said second seal piece is an annular wiper.

16. The capless retractable sealed writing instrument of claim 5, wherein said marker reservoir also comprises at least one internal vent tube in fluid communication with the exterior side of the seal portion when the marker nib is in the extended position.

17. The capless retractable sealed writing instrument of claim 5, wherein said reservoir also includes an airtight plug in an end opposite from said nib.

18. The capless retractable sealed writing instrument of claim 5, wherein said housing having a contoured profile, with an indentation proximate the tip portion for facilitating a writer's grip between thumb and forefinger and having a partially non-circular radial shape to inhibit the marker from rolling on a tilted flat surface.

19. The capless retractable sealed writing instrument of claim 5, wherein the chamber portion also having a plurality of interior vertical ribs spaced generally-symmetrically about the internal circumference of the chamber walls.

20. The capless retractable sealed writing instrument of claim 5, wherein said marker housing also includes a second spring disposed between the plunger and the marker reservoir to absorb impact created by said release spring when released.
